(19) United States
(12) Patent Application Publication
(10) Pub. No.: US 2006/0227110 A1
(43) Pub. Date: Oct. 12, 2006

(54) Storage device for a cleaning cloth

(75) Inventor: Ho-Hsin Liao, Taipei (TW)

Correspondence Address: BACON & THOMAS, PLLC, 625 SLATERS LANE, FOURTH FLOOR, ALEXANDRIA, VA, 22314, US

(73) Assignee: BENEXT INNO-PRODUCT DEVELOPMENT LTD., Taipei (TW)

(21) Appl. No.: 11/156,539

(22) Filed: Jun. 21, 2005

(30) Foreign Application Priority Data
Apr. 7, 2005 (TW) 094110962

(51) Int. Cl. G09G 5/08

(52) U.S. Cl. 345/163

(57) ABSTRACT

A storage device for a cleaning cloth has the shape of a computer mouse. The storage device for a cleaning cloth includes a computer mouse device, a movable shell and a storage space. The position of the storage space for the cleaning cloth is between the mouse casing and the movable shell. An open state and a closed state of the movable shell correspond to the mouse casing. When the movable shell is in the open state, a user can insert and remove the cleaning cloth.

### BACKGROUND OF THE INVENTION

1. Field of the Invention

The present invention relates to a storage device for a cleaning cloth and, more particularly for such cleaning cloths that are used for cleaning computer screens or eyeglasses.

2. Description of the Related Art

Because computer screens or eyeglasses are easily dirtied, they require frequent cleaning. Many users prefer to use cleaning cloths (e.g. 3M™ cleaning cloths) to clean computer screens or eyeglasses because of the convenience that such cloths offer. However, many users have trouble finding a proper place to keep the cleaning cloth from getting dirty. For example, many computer users just put their cleaning cloths on desks or in drawers. As a result, the cleaning cloths are easily dirtied. In addition, many computer users often forget where they have placed their cleaning cloths. Therefore, it is necessary to solve the above-indicated problems.

### SUMMARY OF THE INVENTION

As many people have trouble finding a proper place for storing a cleaning cloth, a primary objective of the present invention is to utilize the spare space of a computer mouse as storage for a cleaning cloth. Although the computer mouse is located near the computer screen, no one has realized that the computer mouse is an ideal location for a cleaning cloth. Once the computer mouse is used as a storage space, a user can conveniently access and store the cleaning cloth and will almost always remember where the cleaning cloth is.

A storage device for a cleaning cloth of the present invention has a shape typical of that for computer mice. The storage device for a cleaning cloth comprises a mouse device, a movable shell and a storage space. The storage space may be used to store a cleaning cloth, and is positioned between the mouse casing and the movable shell. The movable shell has an open state and a closed state, when the movable shell is in the open state, the user can easily place the cleaning cloth in the storage space, or remove the cleaning cloth from the storage space.

Because the typical computer mouse has extra space suitable for storage, the present invention simply utilizes such extra space. Furthermore, many users also wear eyeglasses so that it is very convenient for users not only to clean computer screens but also their eyeglasses.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a first embodiment of a storage device for a cleaning cloth according to the present invention.

FIG. 2 is a cross-sectional schematic drawing of a first embodiment of the storage device for a cleaning cloth according to the present invention.

FIG. 3 is a cross-sectional schematic drawing of a second embodiment of the storage device for a cleaning cloth according to the present invention.

FIG. 4 is a cross-sectional schematic drawing of a third embodiment of the storage device for a cleaning cloth according to the present invention.

FIG. 5 is a cross-sectional schematic drawing of a fourth embodiment of the storage device for a cleaning cloth according to the present invention.

FIG. 6 is a cross-sectional schematic drawing of a fifth embodiment of the storage device for a cleaning cloth according to the present invention.

### DETAILED DESCRIPTION OF THE PREFERRED EMBODIMENT

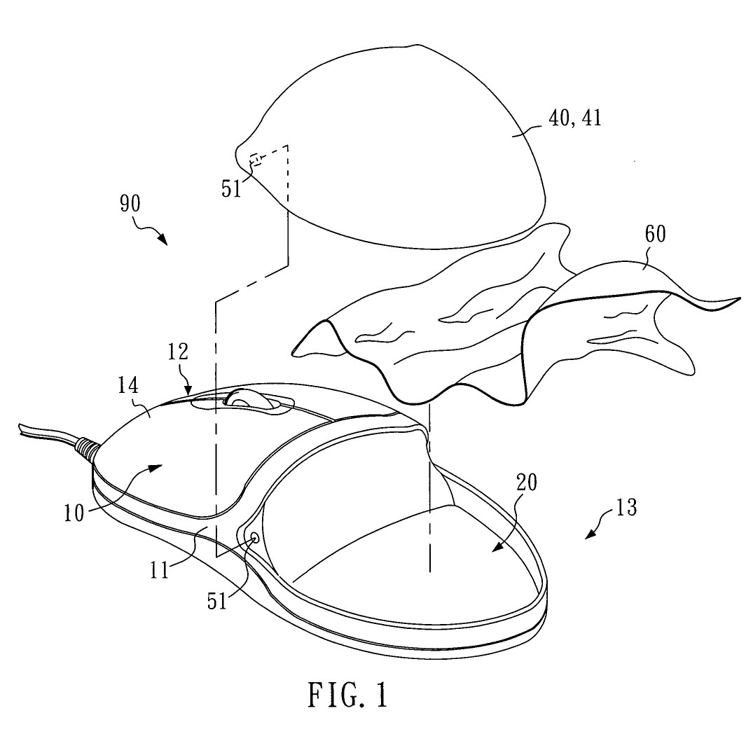

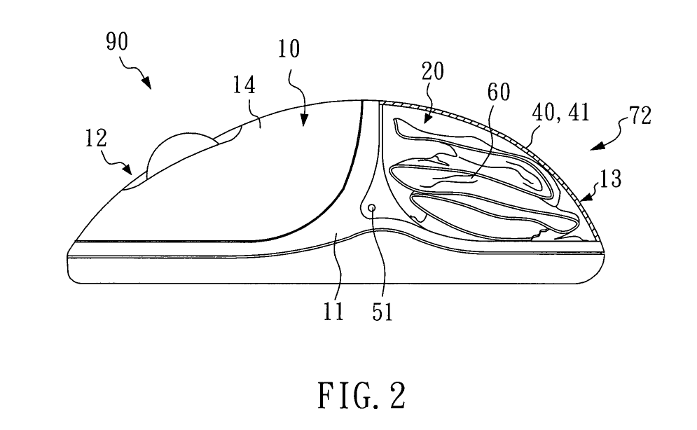

Please refer to FIG. 1 and FIG. 2 for the first embodiment of the present invention. A storage device for a cleaning cloth 90 has the shape typical of computer mice. The storage device for a cleaning cloth 90 comprises a mouse device 10, movable shell 40 and a storage space 20.

The mouse device 10 includes a mechanism that provides the functionality of a standard computer mouse (such as mouse buttons 14) and an electronic device (not shown). Since the mouse device 10 is a well-known technology, it requires no further description.

In the first embodiment, a movable shell 40 is a lifting-style shell 41. The lifting-style shell 41 is connected with the mouse casing 11 of the computer mouse device 10 through a pivoting member 51 so that the lifting-style shell 41 provides an open state and a closed state. FIG. 2 shows the lifting-style shell 41 in the closed state 72. Since the pivoting member 51 is a well-known technology, it requires no further description.

The storage space 20 is suitable for storing a cleaning cloth 60, and is positioned between the mouse casing 11 and the movable shell 40. A user can life the lifting-style shell 41 and take out the cleaning cloth 60. The storage space 20 is placed at the rear portion 13 of the computer mouse device 10, since the mouse buttons 14 and the other electronic devices are disposed towards the front portion 12 of the computer mouse device 10. Uses for the cleaning cloth 60 include cleaning a computer screen or eyeglass. Because a computer is a necessary tool in the work environment of many users, it is a real convenience for such users to have access to the cleaning cloth 60.

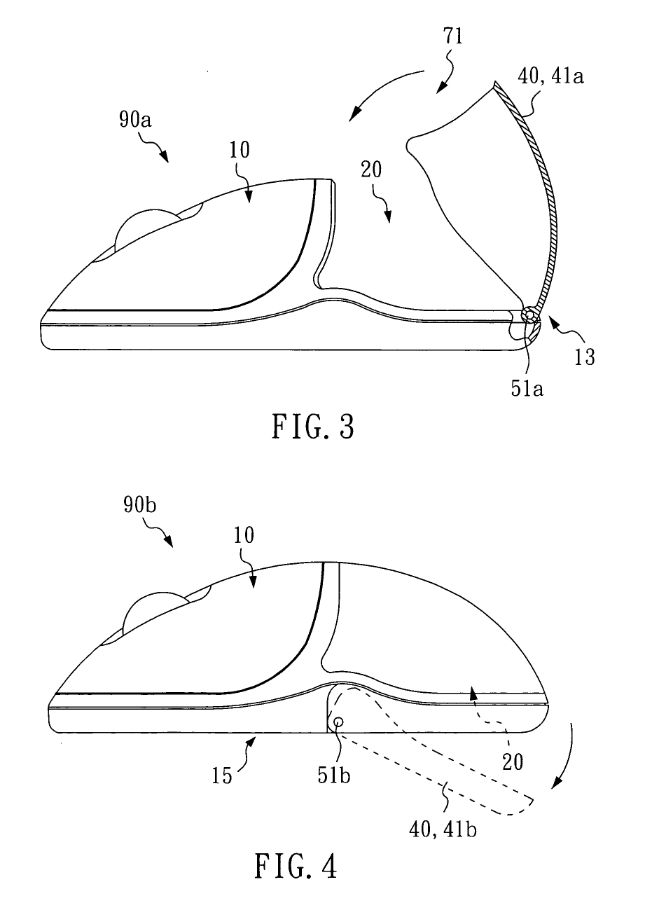

Please refer to a second embodiment of the present invention shown in FIG. 3. The major difference between the first and second embodiment is that the pivoting member 51a of a storage device for a cleaning cloth 90a is placed near the rear portion 13 of the computer mouse device 10. Therefore, the lifting-style shell 41a can be lifted backwards.

Please refer to a third embodiment of the present invention, shown in FIG. 4. The major difference between the first and third embodiment is that the pivoting member 51b of a storage device for a cleaning cloth 90b is placed on the bottom portion 15 of the computer mouse device 10. Therefore, the lifting-style shell 41b can be lifted downwards.

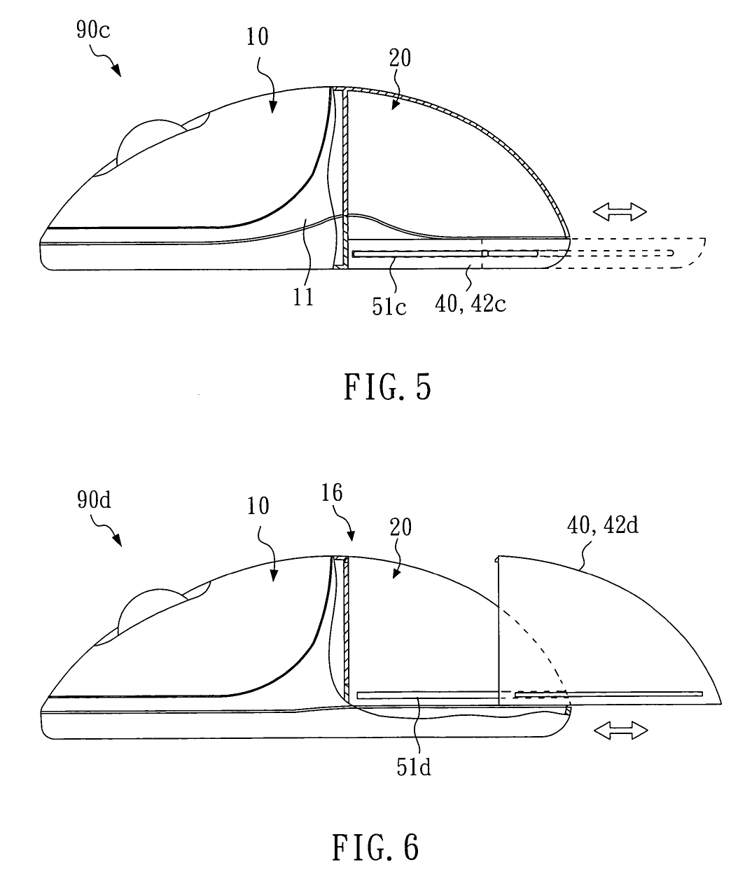

Please refer to a fourth embodiment of the present invention, shown in FIG. 5. The major difference between the fourth and third embodiment is that the movable shell 40 is a sliding-style shell 42c in a storage device for a cleaning cloth 90c. The sliding-style shell 42c can be pulled out like a drawer. One of the simpler methods to achieve such functionality is to have a track member 51c placed on the connecting portion of the sliding-style shell 42c and the mouse casing 11.

Please refer to a fifth embodiment of the present invention shown in FIG. 6. The major difference between the fifth and fourth embodiment is that a sliding-style shell 42d of a storage device for a cleaning cloth 90d is located on the upper portion 16 of the computer mouse device 10. Similarly, a track member 51d is placed on the connecting portion of the sliding-style shell 42d and the mouse casing 11.

In addition, to permit the user to remember or see where the cleaning cloth 60 is, at least portions of the lifting-style shells 41, 41a and the sliding-style shell 42d are transparent. As for the third and fourth embodiments, at least portions of the rear portion 13 of the mouse casing 11 are transparent.

Although the present invention has been explained in relation to its preferred embodiment, it is to be understood that many other possible modifications and variations can be made without departing from the spirit and scope of the invention as hereinafter claimed. For example, the material used for the cleaning “cloth” need not necessary be made from “traditional cloth”, since there are many new materials that have been developed with different names. For purposes of the disclosed invention, the definition of “cloth” is intended to refer to any “wiping sheet”, especially those suitable for cleaning the screens or eyeglasses. In addition, the material of the cleaning cloth may be either reusable or single-use.

What is claimed is:

1. A storage device for a cleaning cloth capable of containing a cleaning cloth 60, the storage device comprising:
a computer mouse device, wherein the computer mouse device has a mouse casing;
a movable shell connected to the mouse casing; and
a storage space for storing the cleaning cloth, wherein the storage space is positioned between the mouse casing and the movable shell.

2. The storage device for a cleaning cloth as claimed in claim 1 wherein the computer mouse device has a front portion and a rear portion, and the storage space is positioned in the rear portion.

3. The storage device for a cleaning cloth as claimed in claim 1, wherein the movable shell is a lifting-style shell, which is connected to the mouse casing in a pivoting manner.

4. The storage device for a cleaning cloth as claimed in claim 3 wherein at least a portion of the lifting-style shell is transparent.

5. The storage device for a cleaning cloth as claimed in claim 1 wherein the movable shell is a sliding-style shell.

6. The storage device for a cleaning cloth as claimed in claim 5 wherein at least a portion of the sliding-style shell is transparent.

7. The storage device for a cleaning cloth as claimed in claim 1, wherein the movable shell has an open state and a closed state, and when the movable shell is in the open state the user can place the cleaning cloth in the storage space or remove the cleaning cloth from the storage space.
